(19) United States
(12) Patent Application Publication
(10) Pub. No.: US 2013/0064617 A1
(43) Pub. Date: Mar. 14, 2013

(54) PROCESS FOR PRODUCING STANDARDIZED ASSAY AREAS ON ORGANIC COATINGS

(71) Applicants: Shi Hua Zhang, Wilmington, DE (US); Li Lin, Wallingford, PA (US)

(72) Inventors: Shi Hua Zhang, Wilmington, DE (US); Li Lin, Wallingford, PA (US)

(73) Assignee: E I Du Pont de Nemours and Company, Wilmington, DE (US)

(21) Appl. No.: 13/699,002

(22) PCT Filed: Jun. 29, 2010
(86) PCT No.: PCT/US10/40337

§ 371 Date: Nov. 20, 2012

Related U.S. Application Data
(60) Provisional application No. 61/349,530, filed on May 28, 2010.

(51) Int. Cl. B23B 47/28

(52) U.S. Cl. 408/1 R

(57) ABSTRACT

The present disclosure is directed to a process for producing standardized assay areas on conductive substrates coated with organic coating layers. The process can be used to produce standardized assay areas for corrosion evaluation tests at an accelerated rate.

### FIELD OF DISCLOSURE

The present disclosure is directed to a device for producing standardized assay areas on conductive substrates coated with organic coating layers. The present disclosure is directed to a process for producing standardized assay areas. The device and the process can be used to produce assay areas for corrosion evaluation tests at an accelerated rate.

### BACKGROUND OF DISCLOSURE

Currently, there is no short-term test method, i.e., less than 2 days, for evaluating the long-term corrosion protection performance afforded by a protective coating. Current standard test methods rely primarily on environmental exposure for many days or even many months, and then followed by visual and mechanical testing. Such tests can require long assay time and the results are often not reproducible and difficult to compare.

One of the current standard test methods comprises the steps to scribe coating layers coated a substrate in either an “X” or “#” pattern, also known as cross-hatch pattern. The scribed areas (or lines) would expose the metal substrate under the coating layers to the environment so that corrosion can occur. Since the scribing is usually made manually using a knife or other sharp objects, inconsistent scribe areas can occur and can affect consistency of test results.

Another method is laser ablation. The laser ablation of coating layers over a substrate can produce desired sizes and patterns of defects in coating layers, such as one or more spots or one or more lines. A thin line cutting through the coating layers and exposing underling substrate with a micrometer width can be generated consistency. However, the laser ablation may not penetrate some coatings containing special pigment. In addition, the heat generated can change the property of the coating-substrate interface and affect accuracy of the testing results.

### STATEMENT OF DISCLOSURE

This disclosure is directed to a rotary tool comprising:
a) a rotatable member (10) adapted to receive a cutting element, the rotatable member being electrically conductive;
b) a motive source (11) attached to said rotatable member for rotating the rotatable member, said motive source being electrically insulated from said rotatable member;
c) a motive controller (12) for controlling power supply and rotation directions of the motive source;
d) a sensing device (13) functionally coupled to said motive controller (12), said sensing device being electrically connected to the rotatable member (10) and an electrical reference terminal (14); and
e) a main frame (15) attached to said motive source and a frame base (16) attached to said main frame.

This disclosure is directed to a rotary tool kit comprising;
a) a rotatable member (10) adapted to receive a cutting element, the rotatable member being electrically conductive;
b) a motive source (11) attachable to said rotatable member for rotating said rotatable member;
c) an insulator coupling for coupling said motive source and said rotatable member so that when assembled, said motive source being electrically insulated from said rotatable member;
d) a motive controller (12) for controlling power supply and rotation directions of the motive source; and
e) a sensing device (13) for coupling to said motive controller (12), said sensing device being electrically connectable to the rotatable member (10) and an electrical reference terminal (14).

This disclosure is directed to a process for producing one or more assay areas on a coated article, said coated article comprises a conductive substrate and one or more non-conductive coating layers coated over said conductive substrate, said process comprising the steps of;
(A) providing a rotary tool comprising:
   a) a rotatable member (10) adapted to receive a cutting element, the rotatable member being electrically conductive;
   b) a motive source (11) for rotating the rotatable member, said motive source and said rotatable member being electrically insulated from each other;
   c) a motive controller (12) for controlling power supply and rotation directions of the motive source;
   d) a sensing device (13) functionally coupled to said motive controller (12), said sensing device being electrically connected to the rotatable member (10) and an electrical reference terminal (14); and
   e) a main frame (15) attached to said motive source and a frame base (16) attached to said main frame;
(B) attaching the cutting element to said rotatable member (10), said cutting element being conductive and in conductive contact with said rotatable member;
(C) positioning said coated article at a first position;
(D) connecting said electrical reference terminal (14) to said conductive substrate so that said electrical reference terminal and said conductive substrate are in conductive contact;
(E) providing a forward signal to said motive controller (12) to power said motive source causing forward rotation of said rotatable member and said attached cutting element at a predetermined forward rotation rate;
(F) advancing said cutting element to cut through said one or more non-conductive coating layers at said first position; and
(G) interrupting the power supply to the motive source after a predetermined time delay or a predetermined number of rotations when said sensing device detects a flow of electric current through the rotatable member and the electrical reference terminal.

This disclosure is directed to a rotary tool control unit.

### BRIEF DESCRIPTION OF DRAWING

FIG. 1 shows a schematic presentation of an example of a configuration of an assembled rotary tool and some of the components and parts (A) and schematic view of an example of sensing device connections (B).

FIG. 2 shows a schematic presentation of another example of a configuration of an assembled rotary tool and some of the components and parts.

FIG. 3 shows schematic presentations of side cross-sectional views of assay areas. (A) An assay area exposes the conductive substrate. (B) An assay area with no exposure of the conductive substrate. (C) (F) Assay areas with various assay surface areas and depths.

FIG. 4 shows schematic presentations of side cross-sectional views of assay areas before reverse rotation (A) and (B), and after reverse rotations (C). (D) A schematic presentation of side cross-sectional view of an assay area with a cut into the conductive substrate.

FIG. 5 shows schematic presentations of assay areas patterns. (A) A top down view of an example of an assay area pattern. (B) A side cross-sectional perspective view of the assay area pattern,

### DETAILED DESCRIPTION

The features and advantages of the present DISCLOSURE will be more readily understood, by those of ordinary skill in the art, from reading the following detailed description. It is to be appreciated that certain features of the DISCLOSURE, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

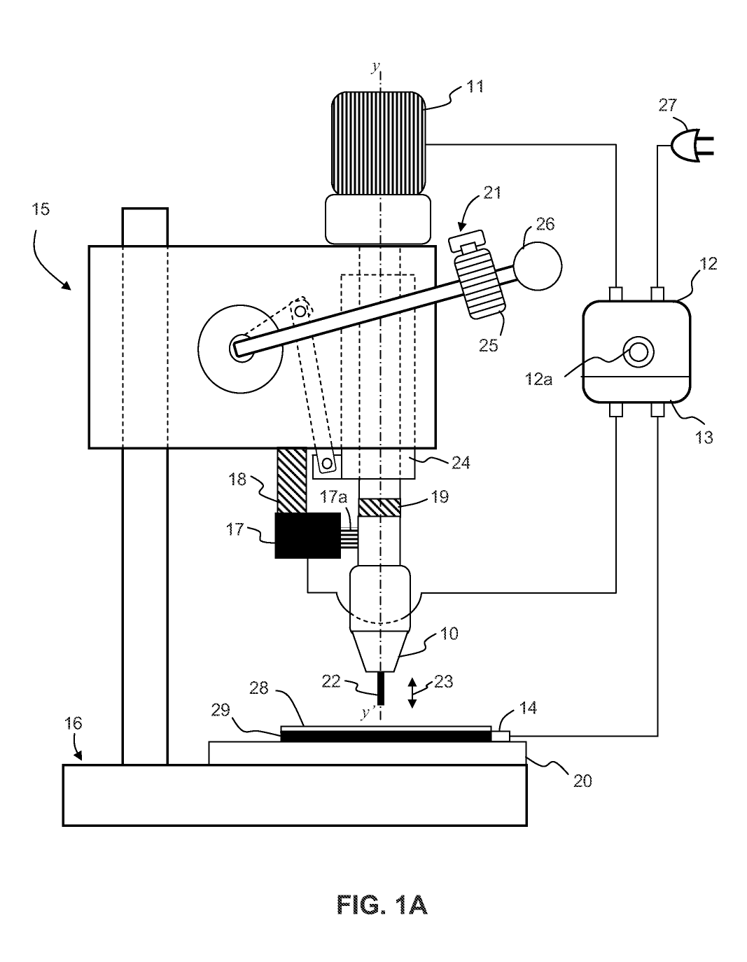

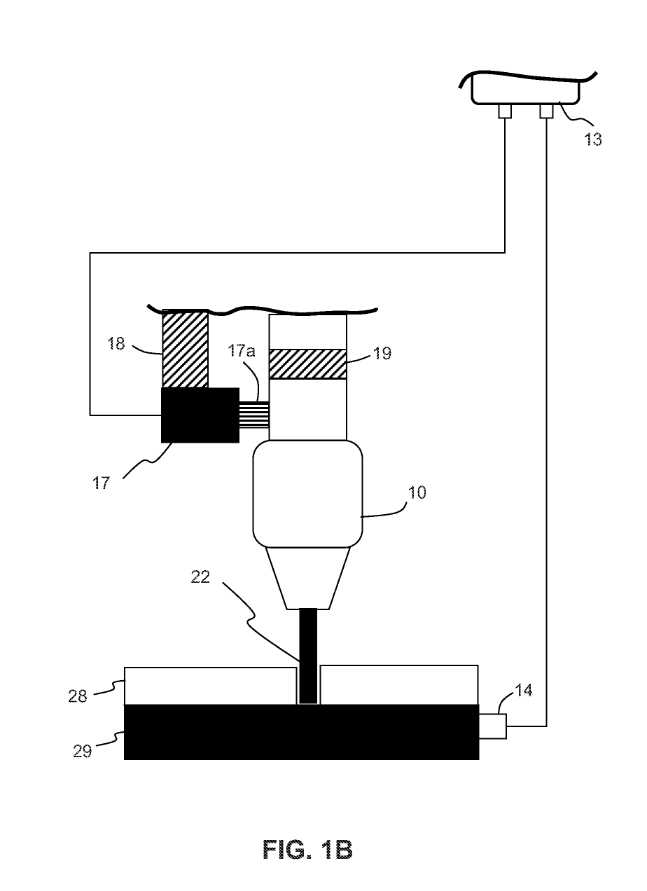

This disclosure is directed to a rotary tool. On example of the rotary tool is shown in FIG. 1. The rotary tool can comprising:

a) a rotatable member (10) adapted to receive a cutting element, the rotatable member being electrically conductive;

b) a motive source (11) attached to said rotatable member for rotating the rotatable member, said motive source being electrically insulated from said rotatable member:

c) a motive controller (12) for controlling power supply and rotation directions of the motive source;

d) a sensing device (13) functionally coupled to said motive controller (12), said sensing device being electrically connected to the rotatable member (10) and an electrical reference terminal (14); and

e) a main frame (15) attached to said motive source and a frame base (16) attached to said main frame,

The rotatable member (10) can comprise a chuck that can receive a cutting element such as a drill bit.

The motive source (11) can be an electric motor. In one example, the motive source can be a DC motor that runs on direct current (DC) electricity. In another example, the motive source can be an AC motor that is driven by alternating current (AC) electricity. The motive source can also be a cranking handle that can be drive by a person. A DC motor can be preferred.

The rotatable member (10) and the motive source (11) can be coupled via a shaft insulating coupling (19) and a shaft coupling (24) that can transmit rotation power from the motive source to the rotatable member. A non-conductive nylon coupling can be suitable as the shaft insulating coupling 9).

The sensing device can apply a low voltage, such as a voltage in a range of from 0.01 V to 36 V, to the rotatable member (10) and the electrical reference terminal (14). Other range of voltages can also be suitable. A low voltage can be preferred since it can produce less spark or heat. A voltage in a range of from 0.01 V to 24 V can be used in one example, a voltage in a range of from 0.01 V to 12 V can be used in another example, a voltage in a range of from 0.01 V to 6 V can be used in yet another example, a voltage in a range of from 0.01 V to 3 V can be used in a further example. The sensing device can detect a flow of electric current through the rotatable member (10) and the electrical reference terminal (14). When the rotatable member (10) and the electrical reference terminal (14) are not in electric contact, electric current will not flow therethrough. When the rotatable member becomes in direct electric contact with the electrical reference terminal, such as both are in direct contact with a conductive substrate, electric current can flow therethrough.

The sensing device can be connected to the rotatable member via a conductive coupler (17) that comprises a constant contact means (17a). The constant contact means can maintain electric contact even when the rotatable member is rotating. In one example, the conductive coupler can be a copper coupler and the constant contact means can be an electric brush. The conductive coupler can be attached to the main frame (15) via a non-conductive adapter (18) so the rotatable member and the main frame can be insulated. An adaptor made from non-conductive nylon or other non-conductive materials can be suitable.

The term “conductive” means electric conductive. The term “insulated” or Insulate” means electric insulated. The term “conductive contact”, “electric contact”, or “electrical contact” refers to electric contact between two or more objects that are electrical conductive that a flow of electric current can flow therethrough.

The motive controller (12) can be configured to control power supply from a power source (27) to the motive source (11). The power source (27) can comprise a transformer to transform alternating current (AC) to direct current (DC), to change electric voltage, to change electric current, or a combination thereof. In one example the power source can comprise a transformer to transform AC to DC and to supply electric power at a low voltage, such as a voltage in a range of from 0.5 V to 36 V. The motive controller (12) can be configured to interrupt the power supply to the motive source after a predetermined time delay or a predetermined number of rotations when the sensing device detects a flow of electric current through the rotatable member and the electrical reference terminal. The predetermined time delay can be in a range of from 0 second to 60 seconds. In one example, the predetermined time delay can be in a range of from 0.01 second to 20 seconds. In another example, the predetermined time delay can be in a range of from 0.01 second to 10 seconds. In yet another example, the predetermined time delay can be in a range of from 0.01 second to 5 seconds. In yet another example, the predetermined time delay can be in a range of from 0.01 seconds to 2 seconds. In yet another example, the predetermined time delay can be in a range of from 0.1 second to 2 seconds. The predetermined number of rotations can be in a range of from 1 to 50 rotations.

The motive controller can be further configured to subsequently provide power supply to the motive source and to cause the motive source to rotate at a reverse rotation direction for a predetermined reverse time period or for a predetermined number of reverse rotations. The predetermined reverse time period can be in a range of from 0.01 second to 50 seconds. The predetermined number of reverse rotations can be in a range of from 1 to 50 rotations.

The motive controller can be configured to cause the motive source to rotate the rotatable member at a forward rotation rate in a range of from 1 to 1000 rpm. The forward rotation rate can be in a range of from 1 to 500 rpm in one example, 5 to 100 rpm in another example, 5 to 50 rpm in yet another example, 5 to 20 rpm in a further example, 5 to 10 rpm in a yet further example.

The motive controller can be configured to cause the motive source to rotate the rotatable member at a reverse rotation rate in a range of from 1 to 1000 rpm. The reverse rotation rate can be in a range of from 1 to 500 rpm in one example, 5 to 100 rpm in another example, 5 to 50 rpm in yet another example, 5 to 20 rpm in a further example, 5 to 10 rpm in a yet further example.

The motive controller can comprise a start device (12a). The start device can be a push button. The start device can be part of the motive controller. The push button can also be extended with a flexible connection so any movements of the push button are not affecting the position of the motive source.

The rotary tool can further comprise a movable work station (20). The movable work station can be movable relative to the frame base (16) in horizontal directions, also referred to herein as x-y directions; vertical directions, also referred to herein as z-directions; or a combination thereof. The horizontal directions are those movements in parallel with the frame base. The vertical directions are those movements getting away from or getting closer to the frame base. The combination of movements in the horizontal and the vertical directions can result in the movable work station in a tilted (also referred to as an angled) position relative to the frame base. The movable work station can be moved manually or by one or more electrical motion means. In one example, the movable work station can be moved by hand. In another example, the movable work station can be moved by a two-dimensional motor for movements in the horizontal directions. In yet another example, the movable work station can be moved by a second two-dimensional motor for movements in the vertical directions. In a further example, the movable work station can be moved in a combination of horizontal and vertical directions by a set of motors. The motors can be control manually or by a computing device.

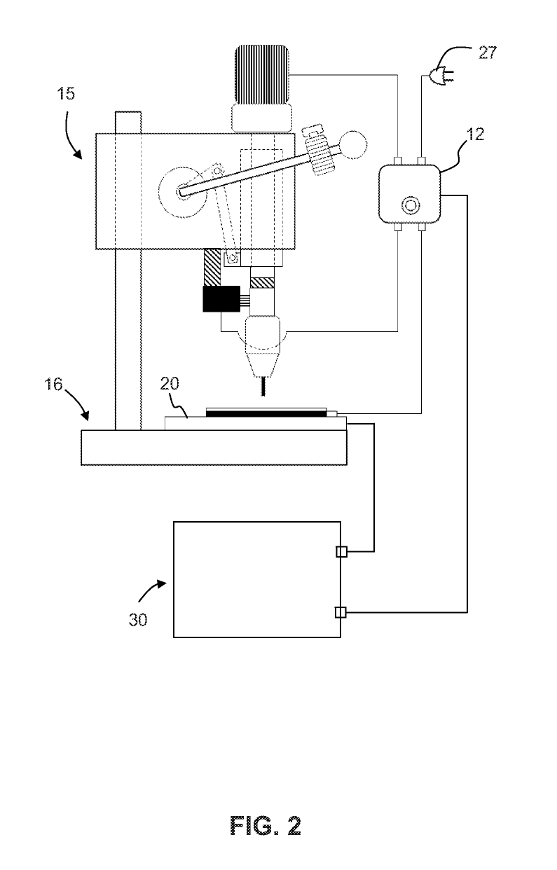

The rotary tool can further comprise a computing device (30) (FIG. 2) functionally coupled to the motive controller, the movable work station, or a combination thereof.

The rotary tool can further comprise an advancing controller (21) for advancing said rotatable member along a rotational axis of the rotatable member. The rotational axis can be referred to as y-y′ in FIG. 1A. The advancing controller can be mechanically coupled to the shaft coupling (24) for moving the rotatable member in directions shown by the arrows (23) in FIG. 1A. In one example, the rotary tool can be set up for operation in a vertical position as shown in FIG. 1A. In such a vertical position, the advancing controller can comprise an advancing weight (25) and an advancing handle (26). The advancing weight (25) can be places at different positions along the advancing handle (26) to produce different advancing force to the rotatable member. A fastener (21) can be used to lock the advancing weight (25) in place. The advancing controller can further comprise a counter balance means to balance the advancing force and to provide an upward force to the rotatable member. A spring means (not shown in FIG. 1) can be used as the counter balance means. In another example, the advancing controller can comprise a set of springs for providing the advancing force and set of counter springs for providing counter balance. The advancing weight can have different weight. For example, it can be in a range of from 20 grams to 1000 grams. The advancing weight can be selected based required advancing force applied to the cutting element that can be measured. In one example, the advancing force can be measured using an analytic balance.

When the cutting element cuts through the non-conductive coating layers (28) and gets in contact with the conductive substrate (29), an electric current can flow through the rotatable member (10) via the conductive coupler (17) that comprises a constant contact means (17a), the conductive substrate and the electrical reference terminal (14). The sensing device can detect the flow of the current and causing the motive source to interrupt power supply to the motive source (FIG. 1B).

The cutting element can have a cutting dimension in a range of from 5 micrometers to 10 millimeters. The term “cutting dimension” of a cutting element refers to the largest cross-sectional dimension of the cutting area of a cutting element. The cross-sectional dimension can be measured perpendicular to the rotational axis of the cutting element. One or more cutting elements can be suitable. One or more types of cutting elements can be used. A combination of cutting elements having different cutting dimensions and types can also be used. In one example, the cutting element can be a drill bit. The drill bit can have one or more straight or helical flutes. The drill bit can have 2, 3 or 4 flutes. The drill can have a flat cutting edge or an angled cutting edge. In another example, the cutting element can be an abrasion tip. The abrasion tip can comprise an abrasion surface having abrasive materials. The abrasive material can be selected from: metal oxide, such as aluminum oxide or chromium oxide; silicon or derivatives, such as silicon carbide; metal alloys, such as alumina-zirconia (an aluminum oxide-zirconium oxide alloy); ceramics; ceramic metal oxide, such as ceramic aluminum oxide; diamond; or a combination thereof.

The cutting element can have different hardness. The cutting element can have the hardness less than, equal to, or higher than the hardness of the conductive substrate. Typical conventional cutting elements, such as steel drill bits can be suitable. A flat end cutting element, such as a flat end drill bit can be used. A cutting element having the hardness less than the hardness of the conductive substrate can be used to produce a cut with just the coating layers removed without cutting into the conductive substrate. A cutting element having the hardness higher than the hardness of the conductive substrate can be used to cut into the conductive substrate.

This disclosure is also directed to a rotary tool kit. The rotary tool kit can be used to assemble the aforementioned rotary tool. The rotary tool kit can comprise:

a) a rotatable member (10) adapted to receive a cutting element, the rotatable member being electrically conductive;

b) a motive source (11) attachable to said rotatable member for rotating said rotatable member;

c) an insulator coupling for coupling said motive source and said rotatable member so that when assembled, said motive source being electrically insulated from said rotatable member;

d) a motive controller (12) for controlling power supply and rotation directions of the motive source; and

e) a sensing device (13) for coupling to said motive controller (12), said sensing device being electrically connectable to the rotatable member (10) and an electrical reference terminal (14).

The rotary tool kit can further comprise:

f) a main frame (15) attachable to said motive source; and

g) a frame base (16) attachable to said main frame.

The rotary tool kit can further comprise a movable work station (20), said movable work station is movable relative to said frame base (16) in horizontal directions, vertical directions, or a combination thereof.

The rotary tool kit can further comprise a computing device (30) capable of being coupled to the motive controller, said movable work station, or a combination thereof.

The rotary tool kit can further comprise a computer program product.

When installed on the computing device, the computer program product can cause the computing device to perform a computing process comprising the steps of:

i) receiving positioning data;

ii) receiving a start signal;

iii) positioning said movable work station to a position according to said positioning data;

iv) producing a forward signal to said motive controller (12) to power said motive source causing forward rotation of said rotatable member at a predetermined forward rotation rate when said sensing device detects no flow of electric current through said rotatable member and said electrical reference terminal; and

v) interrupting the power supply to the motive source after a predetermined time delay when said sensing device detects a flow of electric current through the rotatable member and the electrical reference terminal.

The predetermined time delay can be in a range of from 0 second to 60 seconds. In one example, the predetermined time delay can be in a range of from 0.01 second to 5 seconds.

The computing process can further comprise the steps of:

vi) providing subsequent power supply to said motive source after the step v) and causing said motive source to rotate at a reverse rotation direction for a predetermined reverse time period or for a predetermined number of reverse rotations.

The computing process can further comprises the steps of:

vii) positioning said movable work station to a subsequent position according to said positioning data;

viii) repeating the steps of iv) through viii).

The rotary tool kit can further comprise an advancing controller (21) for advancing said rotatable member along a rotational axis of said rotatable member, said advancing controller being attachable to said rotatable member.

The rotary tool kit can further comprise one or more cutting elements having a cutting dimension in a range of from 5 micrometers to 10 millimeters. Any of the aforementioned cutting elements can be suitable.

Any of aforementioned predetermined forward rotation rates, reverse rotation rates, predetermined reverse time period or predetermined number of reverse rotations can be suitable.

The positioning data can comprise two-dimensional or three-dimensional positioning coordinates, such as x-y coordinates for horizontal positions or x-y-z coordinates for horizontal and vertical positions. The positioning data can be set manually or programmed into a computer readable digital data file and input into the computing device.

The start signal can be produced by an operator or by a computing device programmed therein. In one example, the start device (12a) can be used by the operator to enter the start signal.

The movable work station can be positioned manually or by the computing device.

The rotary tool kit can be packaged in one or more packages and can be assembled by a user.

This disclosure is further directed to a rotary tool control unit. The rotary tool control unit can be coupled to a rotary tool to control its cutting operation. The rotary tool control unit can comprise:
a motive controller and
a sensing device;
wherein said motive controller is attachable to a motive source for controlling power supply and rotation directions of the motive source, said motive source is attachable to a rotatable member and electrically insulated from said rotatable member, said sensing device being electrically connectable to the rotatable member and an electrical reference terminal;
wherein said motive controller is configured to interrupt the power supply to the motive source after a predetermined time delay when said sensing device detects a flow of electric current through the rotatable member and the electrical reference terminal,

This disclosure is further directed to a process for producing one or more assay areas on a coated article. The coated article can comprise a conductive substrate (29) and one or more non-conductive coating layers (28) coated over the conductive substrate. The process can comprise the steps of:

(A) providing a rotary tool comprising:
a) a rotatable member (10) adapted to receive a cutting element, the rotatable member being electrically conductive;
b) a motive source (11) for rotating the rotatable member, said motive source and said rotatable member being electrically insulated from each other;
c) a motive controller (12) for controlling power supply and rotation directions of the motive source;
d) a sensing device (13) functionally coupled to said motive controller (12), said sensing device being electrically connected to the rotatable member (10) and an electrical reference terminal (14); and
e) a main frame (15) attached to said motive source and a frame base (16) attached to said main frame;

(B) attaching the cutting element to said rotatable member (10), said cutting element being conductive and in conductive contact with said rotatable member;

(C) positioning said coated article at a first position;

(D) connecting said electrical reference terminal (14) to said conductive substrate so that said electrical reference terminal and said conductive substrate are in conductive contact;

(E) providing a forward signal to said motive controller (12) to power said motive source causing forward rotation of said rotatable member and said attached cutting element at a predetermined forward rotation rate;

(F) advancing said cutting element to cut through said one or more non-conductive coating layers at said first position; and

(G) interrupting the power supply to the motive source after a predetermined time delay or a predetermined number of rotations when said sensing device detects a flow of electric current through the rotatable member and the electrical reference terminal.

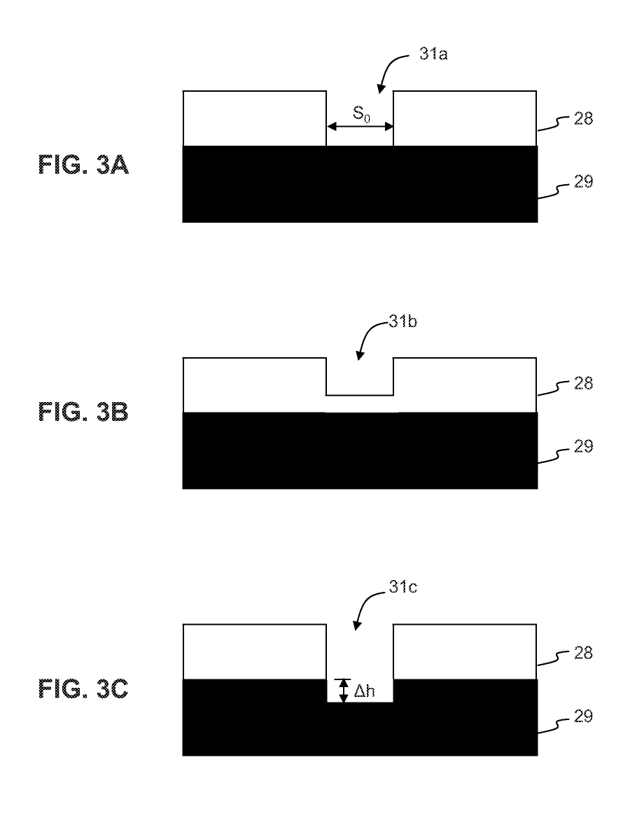

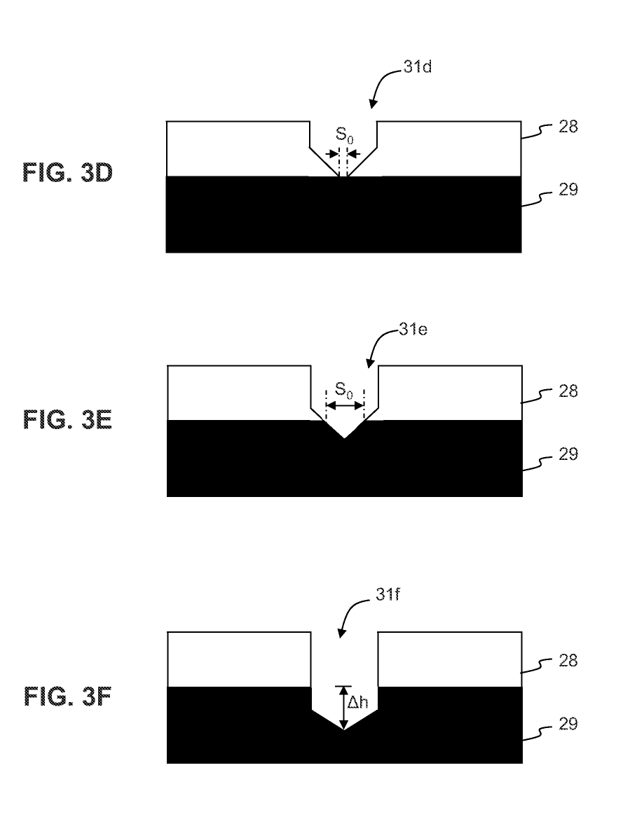

The predetermined time delay or the predetermined number of rotations can allow the motive source and the rotatable member to continue forward rotation, so that the cutting element can continue to cut through and to reach a desired depth (Δh) (FIG. 3), This can be useful for producing consistent and standardized assay areas. In one example, a

The process can further comprise the steps of:

(H) providing subsequent power supply to said motive source after the step (G) and causing said motive source to rotate at a reverse rotation direction for a predetermined reverse time period or for a predetermined number of reverse rotations.

The process can further comprise the steps of positioning said coated article at a subsequent position and repeating the steps (E) and (H) at said subsequent position. A predetermined pattern template can be used to guide for placing the coated article in the first or the subsequent position. In one example, a paper template can be used to layout the positions of assay areas on a coated substrate in a predetermined pattern. In another example, a ruler can be used to guide the layout of assay areas on a coated substrate.

Any of the aforementioned predetermined time delay, predetermined number of rotations, predetermined reverse time period or predetermined number of reverse rotations, forward rotation rates, and reverse rotation rates can be suitable.

The rotary tool can further comprise a movable work station. The movable work station can be movable relative to said frame base (16) in horizontal directions, vertical directions, or a combination thereof.

The coated article can be affixed to the movable work station. Typical fasteners, clamps, clips, elastic bands, or any other affixing means can be suitable.

The rotary tool further comprises the aforementioned computing device functionally coupled to said motive controller, said movable station, or a combination thereof; and aforementioned advancing controller for advancing said rotatable member along a rotational axis of said rotatable member.

The coated article can be a coating test panel, a vehicle body, or a vehicle body part. The coating test panel can comprise a metal substrate and one or more organic coating layer. The coating test panel can also be a part of a structure, such as a part of a bridge, a building or a building part; a machinery, such as a machine part; a vehicle, such as a part of a car, a part of a train, a part of an aircraft, or a part of a water vessel; an appliance, such as a part of a household appliance; a sports equipment; or any other articles or article parts having a conductive substrate and one or more coating layers.

The organic coating layers can have a thickness in a range of from 0.01 millimeter (mm) to 10 mm in one example, 0.01 mm to 5 mm in another example, in a range of from 0.01 mm to 2 mm in another example, in a range of from 0.01 mm to 1 mm in yet another example, in a range of from 0.01 mm to 0.5 mm in yet another example, in a range of from 0.01 mm to 0.1 mm in a further example.

The disclosed process, rotary tool, rotary tool kit or control unit can be used to producing standardized assay areas on organic coatings.

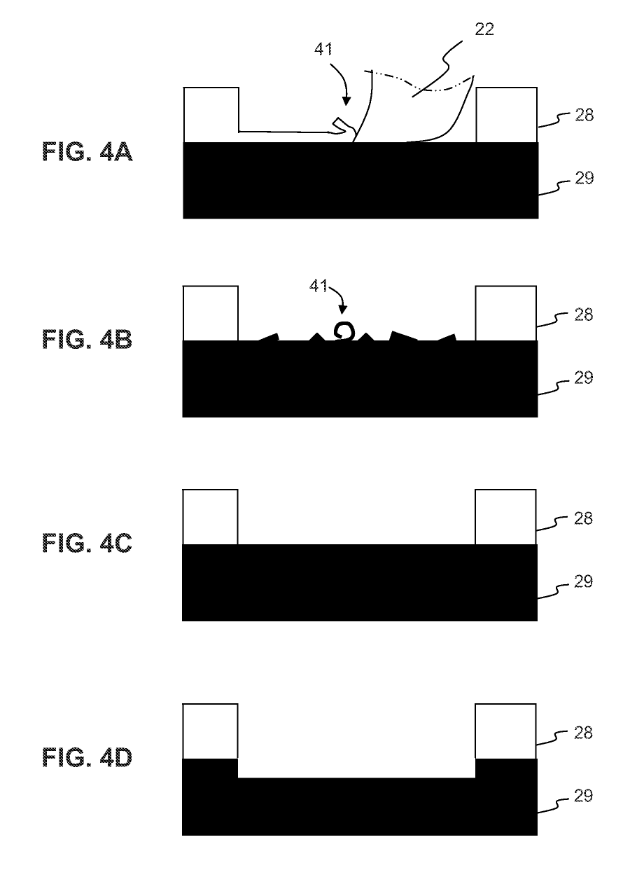

In order to assess properties of the coating layer(s) (28), such as adhesion and corrosion protection, over the conductive substrate (29), one or more small assay areas (31) can be produced (FIGS. 3, 4 and 5). The assay areas can have different variables with different assay surface areas (S₀) of the conductive substrate (31a-31f) (FIG. 3) exposed. The assay surface area (S₀) refers the sum of all surface areas exposed including the side wall areas of the conductive substrate. An under-cut assay area can have some or all of the coating layers still intact (31b, 31d and 31e). An assay area can also have different depth (Δh) cutting into the conductive substrate. When the cutting element stops cutting, it can produce debris or partial cuts (41) (FIGS. 4A and 4B). Such debris or partial cuts can affect size of actual assay area and can affect assay results. All these variables can make comparisons of results from a plurality of assays difficult or impossible.

Using the process of this disclosure, the assay areas can be produced with standardized specifications, such as a specified assay surface area (S₀) and a specified depth (Δh) into the conductive substrate. When the cutting element gets into contact with the conductive substrate, a flow of electric current can occur that flows through the rotatable member, the cutting element and the electrical reference terminal that is electrically connected to the conductive substrate. The motive controller can interrupt the power supply to the motive source after a predetermined time delay or a predetermined number of rotations when the sensing device detects the flow of electric current.

The predetermined time delay or the predetermined number of rotations can depend upon the shape of the cutting element, desired depth into the conductive substrate, or a combination thereof and should be sufficient for producing the desired cuts. In one example, a V-shaped cutting drill bit can be used, and a 5 second delay can be predetermined to allow the drill bit to cut into the substrate at its full cutting dimension. In another example, a flat drill bit can be used and 10 additional rotations can be used to allow the drill bit to cut into the substrate. A combination of predetermined time delay and predetermined number of rotations can also be suitable.

According to the process of this disclosure, a reverse rotation can be used. In one example, the reverse rotation can produce an assay area having a smooth surface by removing debris and partial cuts (FIGS. 4C and 4D). In another example, the reverse rotation can help for withdrawing the drill bit.

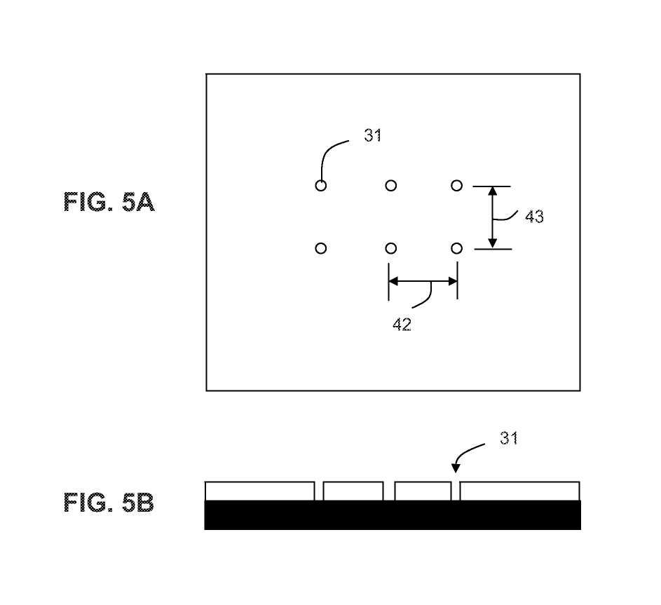

The process of this disclosure can produce standardized assay areas on the coated substrate in a predetermined pattern. In one example, 6 or more assay areas can be produced in multiple rows and columns. Each of the assay areas can have a predetermined distance away from next assay area (42 and 43) (FIG. 5). Each of the assay area can have a diameter of about 300 μm. Distance between to assay areas (42 and 43) can be in a range of from 5 mm to 20 mm.

What is claimed is:

1. A process for producing one or more assay areas on a coated article, said coated article comprises a conductive substrate and one or more non-conductive coating layers coated over said conductive substrate, said process comprising the steps of:
(A) providing a rotary tool comprising;
a) a rotatable member (10) adapted to receive a cutting element, the rotatable member being electrically conductive;
b) a motive source (11) for rotating the rotatable member, said motive source and said rotatable member being electrically insulated from each other;
c) a motive controller (12) for controlling power supply and rotation directions of the motive source;
d) a sensing device (13) functionally coupled to said motive controller (12), said sensing device being electrically connected to the rotatable member (10) and an electrical reference terminal (14); and
e) a main frame (15) attached to said motive source and a frame base (16) attached to said main frame;
(B) attaching the cutting element to said rotatable member (10), said cutting element being conductive and in conductive contact with said rotatable member;
(C) positioning said coated article at a first position;
(D) connecting said electrical reference terminal (14) to said conductive substrate so that said electrical reference terminal and said conductive substrate are in conductive contact;
(E) providing a forward signal to said motive controller (12) to power said motive source causing forward rotation of said rotatable member and said attached cutting element at a predetermined forward rotation rate;
(F) advancing said cutting element to cut through said one or more non-conductive coating layers at said first position; and
(G) interrupting the power supply to the motive source after a predetermined time delay or a predetermined number of rotations when said sensing device detects a flow of electric current through the rotatable member and the electrical reference terminal.

2. The process of claim 1, wherein said predetermined time delay is in a range of from 0 second to 60 seconds.

3. The process of claim 1, wherein said predetermined time delay is in a range of from 0.01 seconds to 5 seconds.

4. The process of claim 1 further comprising the steps of:
(H) providing subsequent power supply to said motive source after the step (G) and causing said motive source to rotate at a reverse rotation direction for a predetermined reverse time period or for a predetermined number of reverse rotations.

5. The process of claim 4 further comprising the steps of positioning said coated article at a subsequent position and repeating the steps (E) and (H) at said subsequent position.

6. The process of claim 4, wherein said reverse rotation rate is in a range of from 1 to 1000 rpm.

7. The process of claim 4, wherein said reverse rotation rate is in a range of from 5 to 20 rpm.

8. The process of claim 1, wherein said predetermined forward rotation rate is in a range of from 1 to 1000 rpm.

9. The process of claim 1, wherein said forward rotation rate is in a range of from 5 to 20 rpm.

10. The process of claim 1, wherein said rotary tool further comprises a movable work station, said movable work station is movable relative to said frame base (16) in horizontal directions, vertical directions, or a combination thereof.

11. The process of claim 10, wherein said coated article is affixed to said movable work station.

12. The process of claim 10, wherein said rotary tool further comprises a computing device functionally coupled to said motive controller, said movable station, or a combination thereof.

13. The process of claim 1, wherein said rotary tool further comprises an advancing controller for advancing said rotatable member along a rotational axis of said rotatable member.

14. The process of claim 1, wherein said coated article is a coating test panel, a vehicle body, or a vehicle body part.
